(19) United States
(12) Patent Application Publication
(10) Pub. No.: US 2023/0304533 A1
(43) Pub. Date: Sep. 28, 2023

(54) BEARING DEVICE FOR POINTING DEVICES

(71) Applicant: TRAPPER HOLDING AB, Järfälla (SE)

(72) Inventor: Rolf Eric Ragnar STRÖMBERG, Skä (SE)

(21) Appl. No.: 18/040,870

(22) PCT Filed: Aug. 10, 2021
(86) PCT No.: PCT/SE2021/000007

§ 371 Date: Feb. 7, 2023

(30) Foreign Application Priority Data
Aug. 10, 2020 (SE) 2000136-8

(51) Int. Cl. F16C 27/02; F16C 17/02; F16C 33/20

(52) U.S. Cl. CPC F16C 27/02; F16C 17/02; F16C 33/201; F16C 2208/60

(57) ABSTRACT

A bearing device (10) for a pointing device (1) and arranged between an operating cylinder (5) and its center shaft (6) to dampen/eliminate friction, vibrations and/or noises within or from the pointing device (1) can include an insulating bushing (12) formed of a damping material. The damping material can include at least in part fibers or is made of a fibrous material (13).

### TECHNICAL AREA

The present invention relates to a bearing device for use with a rotating bar device of a pointing device and which enables its operating cylinder to perform axial and rotational movements in relation to a center shaft, with low friction and without disturbing noises.

The object of the invention is that the bearing device according to the invention is to dampen vibrations and noises from the bar in the pointing device, and thereby enable the use of an operating cylinder with an advantageously larger diameter and greater length than is possible/suitable with known technology.

This achieves a more functional pointing device with greater user-friendliness, ergonomics and efficiency.

### PRIOR ART

A common and widely used pointing device today is the so-called mouse that dominates the market for use with e.g. desktop computers. However, the mouse has a significant disadvantage, namely that the user has to move the hand from the keyboard and place it over the mouse, which usually is located some distance away and at the side of the keyboard, in order to be able to move the cursor/marker on the screen.

For this reason, pointing devices have been developed that can be located between the user and the keyboard, designed with a substantially rigid operating cylinder rotatable about a central shaft and axially displaceable/translatable. With the help of the operating cylinder, a user can with great precision control a cursor/marker on a monitor at, for example, a computer or a similar electronic device. This in order to give the user a good comfort and a natural working position which thereby reduces unnecessary muscle tension when working with a computer. Such a pointing device can also be designed with soft wrist support to reduce the static load, extra button functions, etc.

Rotation of the operating cylinder about its axis of symmetry moves the cursor/marker vertically on the computer screen and axial movement/translation of the operating cylinder moves the cursor/marker horizontally on the display/screen.

The advantage of pointing devices of this type is that the user only needs to move the hand a limited distance from the keyboard to reach the operating cylinder. The response between the movements of the operating cylinder and the movement of the cursor/marker on the screen is as direct as in a conventional computer mouse. The operating cylinder can be easily rotated/displaced on the center shaft, which results in very good usability.

A disadvantage of pointing devices of this type is that if the operating cylinder has a small diameter, the surface of the operating cylinder which is to be affected by the user also becomes small, which makes it difficult to maneuver the cursor in a desired manner, especially when the cursor is to be moved in the vertical direction. The larger the diameter of the operating cylinder is, the easier the vertical movement of the cursor can be achieved.

This has resulted in a pointing device commonly used on the market being provided with an operating cylinder with a diameter of about 18 mm, which is clearly larger than the diameter of operating cylinders of other pointing devices of a corresponding type, which is often in the order of 12 mm. However, the operating cylinder of this pointing device has been manufactured with a significantly shorter length, typically about 180 mm, compared to a desired length of 300 mm or more.

A long operating cylinder makes it easier for the user to optionally use one or both hands to operate the cursor on the display. The ideal for pointing devices of this type would thus be an operating cylinder with the larger length and the larger diameter. However, it has been found that larger operating cylinders more easily create vibrations and noises, which is a disadvantage especially when the pointing device is used in a relatively quiet working environment, such as in an office or in an office landscape.

An optimally functioning pointing device featuring an operating cylinder should e.g. meet the following requirements:
1) The diameter and length of the operating cylinder should both be relatively large.
2) The friction between the operating cylinder and its center shaft must be so low that the user feels comfortable handling the operating cylinder. This in turn requires that the weight of the operating cylinder must be kept low, as a heavy operating cylinder results in higher friction.
3) Pointing devices of this type are usually used in office environments and it is essential that disturbing noises or vibrations do not occur during use.

It has been found that these three requirements are in practice difficult to meet at the same time. This depends on that if the operating cylinder is made with a larger diameter and is also made longer, the operating cylinder must be made thin-walled to keep its weight within the desired margins. Thus, it needs to be made of a light and rigid material such as, for example, aluminum or carbon fibers. Also, if the operating cylinder is manufactured with a larger diameter and greater length, vibrations and noise that occur in the bearings between the operating cylinder and its center shaft are more easily transferred to the environment due to the larger surface area of the operating cylinder, which can then be perceived as disturbing when the pointing device is used.

Attempts have been made with known technology to minimize the spread of noise from the operating cylinder device to the environment via the operating cylinder by covering the outside of the operating cylinder with a thin-walled outer rubber cylinder, which thereby dampens resonances in the operating cylinder and partially reduces noise from the cylinder to the environment. However, the length of the operating cylinder thus needs to be limited with known technology and known bearing designs, in order to reduce the total weight of the operating cylinder and the rubber cylinder to reduce the friction to an acceptable level.

It has thus been desirable to limit the area of the outer surface of the operating cylinder, since this surface transmits vibrations and noises which arise in the construction to the ambient air. The larger the surface area, the greater the noise transmission.

Prior art thus has a number of problems/disadvantages.

For the reasons mentioned, there is a need to improve the technology around operating cylinders to demonstrate a design which makes it possible to use an operating cylinder with a larger diameter and greater length but which still keeps disturbing noises and vibrations, when used, at a low and acceptable level.

### SUMMARY OF THE INVENTION

An object of the present invention is thus to solve the above-mentioned problems and to demonstrate a pointing device, for use in computers or similar electronic devices, which allows the use of an operating cylinder with a larger diameter and with a larger length but which by its design reduces friction, noise and vibration during use.

A further object of the invention is to demonstrate a bearing device which is arranged to be located between the operating cylinder of the pointing device and its center shaft, which minimizes the friction between the operating cylinder and the center shaft, and which reduces resonances and noises in these parts which can be spread to the environment.

A further object of the invention is to demonstrate a pointing device which comprises few and constructively simple components.

A further object of the invention is that the bearing device should be simple and inexpensive to manufacture and assemble.

A further object is that the bearing device should have a long service life.

By achieving the above objects, a more functional pointing device is achieved with increased user-friendliness and with better ergonomics and efficiency.

These and further objects and advantages are achieved according to the invention by a device defined by the features stated in the characterizing part of the independent claim 1 which defines a bearing device mainly intended for a pointing device and arranged to dampen or eliminate vibrations and noises from the pointing device and/or reduce the friction between its operating cylinder and center shaft in that the operating cylinder comprises an insulating bushing essentially consisting of a damping material, such as for instance a material made of a fibers.

The features and advantages of the invention will become apparent from the following, more detailed description of the invention, and from the accompanying drawings and other claims.

### SHORT DESCRIPTION OF THE DRAWINGS

The invention is described in more detail below in some preferred embodiments with reference to the accompanying drawings.

FIG. 1 shows a pointing device in perspective obliquely from above.

FIG. 2 shows a pointing device in the corresponding perspective view as in FIG. 1, but here the upper housing part of the pointing device is removed.

FIG. 3 shows, in a corresponding perspective view as in FIGS. 1 and 2, a section through the operating cylinder and its center shaft and through some rear housing part of the pointing device.

FIG. 4 shows in perspective, obliquely from above, an example of an as not yet mounted insulating bushing in the form of a material mainly made of fibers.

FIG. 5 shows in a corresponding perspective view, as in FIGS. 1-3, in more detail an end portion of the operating cylinder, with a bearing cup surrounding the center shaft.

FIG. 6a shows in perspective view an exposed bearing device according to the invention.

FIG. 6b shows in perspective a section through the bearing device according to FIG. 6a.

FIG. 6c shows in perspective a section through an alternative embodiment of a bearing device.

FIG. 7a shows in perspective view a bearing device according to the invention corresponding to that shown in FIG. 6a and b but here arranged with an inner hard surface layer in the form of a ring, fixed to the inner surface of the insulating bushing.

FIG. 7b shows in perspective a section through the bearing device according to FIG. 7a.

FIG. 8 shows a section through a bearing device according to the invention and where the insulating bushing slides against the center shaft.

FIG. 9 shows a section through the operating cylinder and the center shaft shown in FIG. 8, but where the insulating bushing is provided with an alternative inner hard surface layer.

### DESCRIPTION OF PREFERRED EMBODIMENTS

The present invention thus relates to a pointing device intended to enable axial and rotating movements of an operating cylinder mounted on a center shaft and with which operating cylinder a user can control a cursor/marker on a display/screen at for example a computer or similar electronic device.

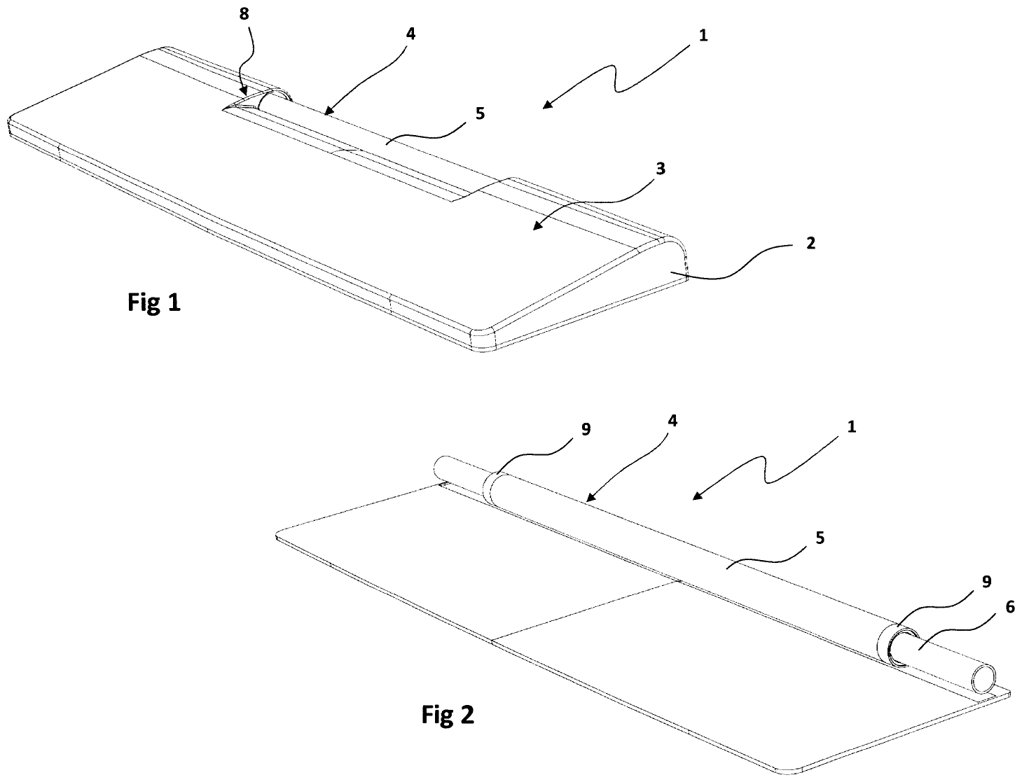

FIG. 1 shows a pointing device 1 in perspective, obliquely from above. The pointing device 1 basically consists of a housing 2 or a cover which at its upper surface 3 can be provided with wrist support, buttons/keys for various functions, etc. (not shown). The pointing device 1 is intended to be located appropriately between a computer keyboard and a monitor/display/screen (not shown). The pointing device 1 mainly comprises an operating cylinder 5 which rotates/slides on a center shaft 6 which in turn can be a cylinder of smaller diameter (see for example FIG. 2). The center shaft 6 is at its end portions suitably fixedly arranged in the housing/chassis 7 of the pointing device. A user can manually actuate/maneuver the operating cylinder 5 through a control opening 8 arranged in the upper surface 3 of the pointing device 1 by rotating the operating cylinder 5 around its center shaft 6 or displacing it along the center shaft 6 with the hand/fingers and thereby control/move a cursor/marker on a connected computer monitor/display (not shown).

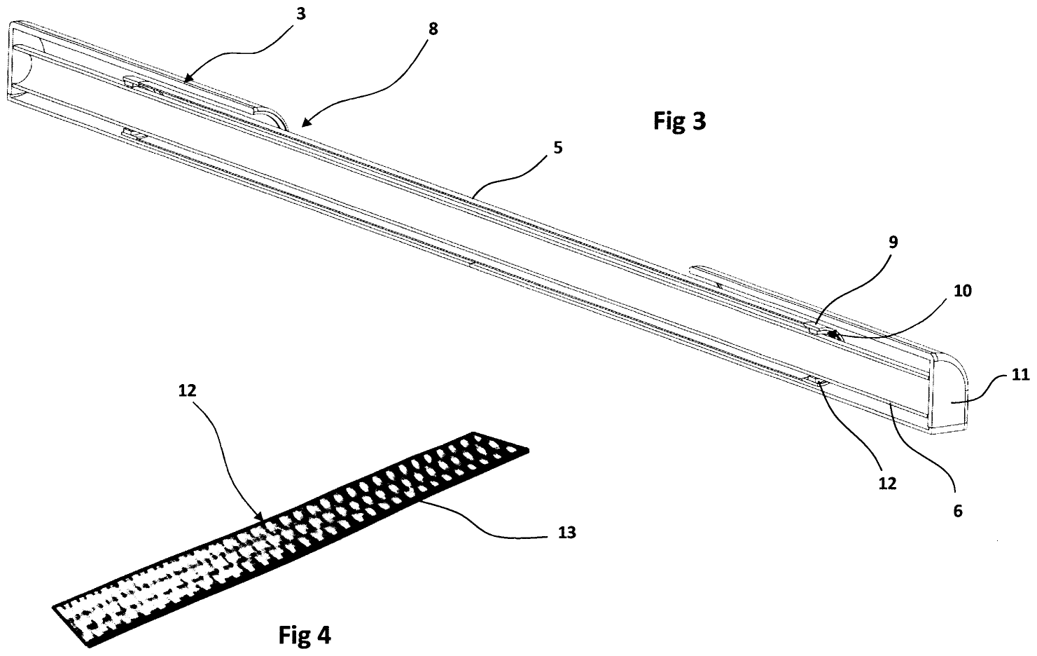

FIG. 2 shows a pointing device 1 in the corresponding perspective as in FIG. 1, but here the upper housing part is removed to show more clearly the location and construction of the operating cylinder device 4. The displaceable and rotatable operating cylinder 5 slides/rotates along/around the center shaft 6. The center shaft 6 is mechanically mounted at its end portions in the housing/chassis 7 of the pointing device in a suitable manner (not shown in detail). The figure shows how two cylindrical bearing cups 9 are mounted, one at each end of the operating cylinder 5 which by means of bearing devices 10 (see e.g. FIG. 3) allows the operating cylinder 5 to slide along, and rotate around, the center shaft 6.

FIG. 3 shows in a corresponding perspective view as FIGS. 1 and 2 a longitudinal section through the center shaft 6, the operating cylinder 5 and the bearing devices 10. A part of the upper rear part 11 of the housing is also visible here to illustrate how the center shaft 6 can be fixed to the housing at its end portions, but this is not important to this invention; the ends can be fastened for instance to click sensors (not shown) as well. As previously mentioned, the housing 3 is provided with an operating opening 8 which allows the user to reach the operating cylinder 5 with his hand or with his fingers. Bearing cups 9, here with substantially the same outer diameter as the actuating cylinder 5, are in this exemplary embodiment glued edge to edge to the actuating cylinder 5. Alternatively, the bearing cups 9 may be designed to be pressed slightly into the ends of the operating cylinder 5 (not shown).

Arranged in the bearing cups 9 are insulating bushings 12 located and mounted in such a way that they abut at least partially against the center shaft 6. In order to reduce the friction between the bearing devices 10 and the center shaft 6 as far as possible, a play may be allowed between the insulating bushing 12 and the center shaft 6 (not shown in detail). The play should typically be at least 0.8 mm but can be smaller or larger.

It should be clarified that the bearing cups 9 are not necessary for the function, they may be left out and the insulating bushings 12 are then fixed directly to the inside of the operating cylinder 5. The bearing cups 9 also do not have to be located at the ends of the operating cylinder 5, they can be located anywhere inside the operating cylinder 5.

It is essential that the weight of the operating cylinder 5 is low, and it can advantageously be made of aluminum, magnesium, carbon fiber or the like. Of course, other low-density, rigid materials can also be used. Said materials have the disadvantage, however, that they easily transmit sound vibrations to the environment mainly due to their relatively high stiffness.

According to the present invention, the problem of noise and vibration is solved in that the bearing device(s) 10 according to the invention are arranged to reduce the amount of vibrations occurring when the operating cylinder 5 is rotated around or slid along the center shaft 6, and in that the bearing devices 10 themselves dampen such vibrations or noises and do not lead them on to the operating cylinder 5. This eliminates or reduces the risk of vibrations/noises occurring in the construction being transmitted to the environment by the components of the pointing device 1.

The bearing cup 9 consists, as mentioned, of an outer ring made of a substantially hard material, such as e.g. of steel, aluminum, magnesium or similar.

FIG. 4 shows in perspective, obliquely from above, an example of a basic material for an insulating bushing 12 according to the invention which in mounted condition is placed in a bearing cup 9 or directly inside the operating cylinder 5. The insulating bushing 12 consist of, or comprises, a resilient/soft/damping material which is durable and having a low friction, advantageously a fibrous material 13 such as a woven fabric, felt or mat, alternatively a combination of these materials. The fibers themselves do not necessarily have to be made of a soft or damping material, but by arranging the fibers as a fabric 13 or as a blanket or mat, the insulating bushing 12 is given an advantageous damping function in the application according to the invention. The fabric 13 can be a thin fabric made of, for example, polyamide, which provides good wear resistance and low friction. Other materials, such as polyester or the like, are also fully possible to use. In unassembled condition, the insulating bushing 12 preferably consists of a long-narrow punched piece of such a soft/cushioning fabric 13 or fabric/felt/carpet. The insulating bushing 12 can advantageously be provided on one side with a thin layer of an adhesive, such as e.g. a heat adhesive, and is mounted by this against the inside of the bearing cup 9 or the operating cylinder 5 by means of a specially designed tool and simultaneous heating so that the insulating bushing 12 attaches to the bearing cup 9 or to the inside of the operating cylinder 5 and is thereby formed into a circular shape. A groove 14 or a gap (not shown) may be allowed to occur between the ends of the insulating bushing 12 in its mounted condition.

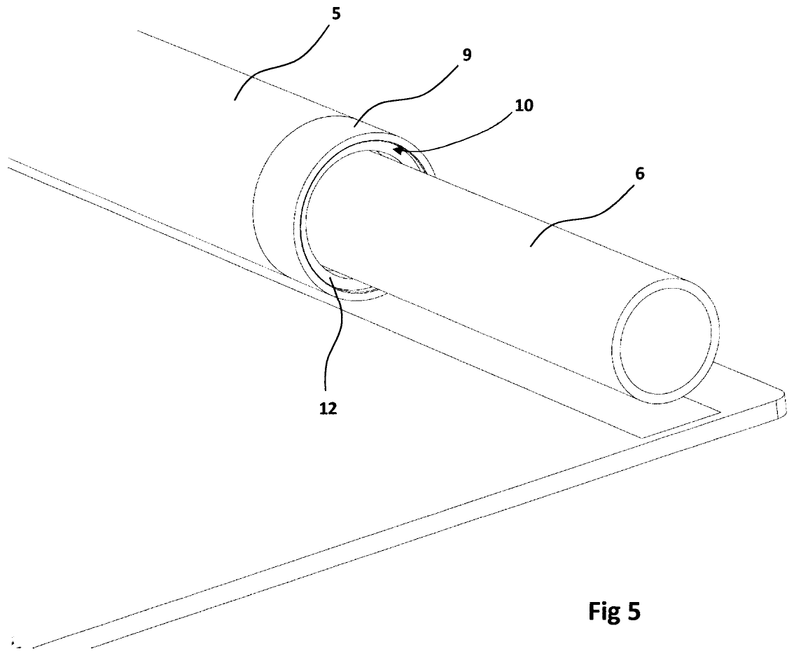

FIG. 5 shows in a corresponding perspective view as in FIGS. 1-3, in more detail, one end portion of the operating cylinder 5 and the center shaft 6. Here the bearing device 10 according to the invention is mounted in a bearing cup 9, which is fixed to the end portion of the operating cylinder 5 and which holds the actuating cylinder 5 at a certain distance in relation to the center shaft 6 but allows the actuating cylinder 5 to slide against or rotate about the center shaft 6. The bearing cup 9 is made of a substantially hard circular/cylindrical material. The bearing cup 9 can be pressed completely or partially into the ends of the operating cylinder 5 or alternatively fastened/glued to the end edges of the operating cylinder 5 and is thus mechanically fixedly arranged in/against the operating cylinder 5. It should be noted that the construction of the bearing device 10 with an inner softer insulating bushing 12, a substantial clearance may be allowed between the insulating bushing 12 and the center shaft 6, for example 0.8 mm. However, the gap can be both larger and smaller. A bearing device 10 of conventional type of e.g. hard plastic, such as polyethylene, gives rise to a disturbing “rattling” noise when the operating cylinder 5 e.g. is operated quickly by the user, provided that such a bearing device 10 is designed with a larger play (i.e. if it is manufactured with a substantially larger inner diameter compared to the outer diameter of the center shaft 6).

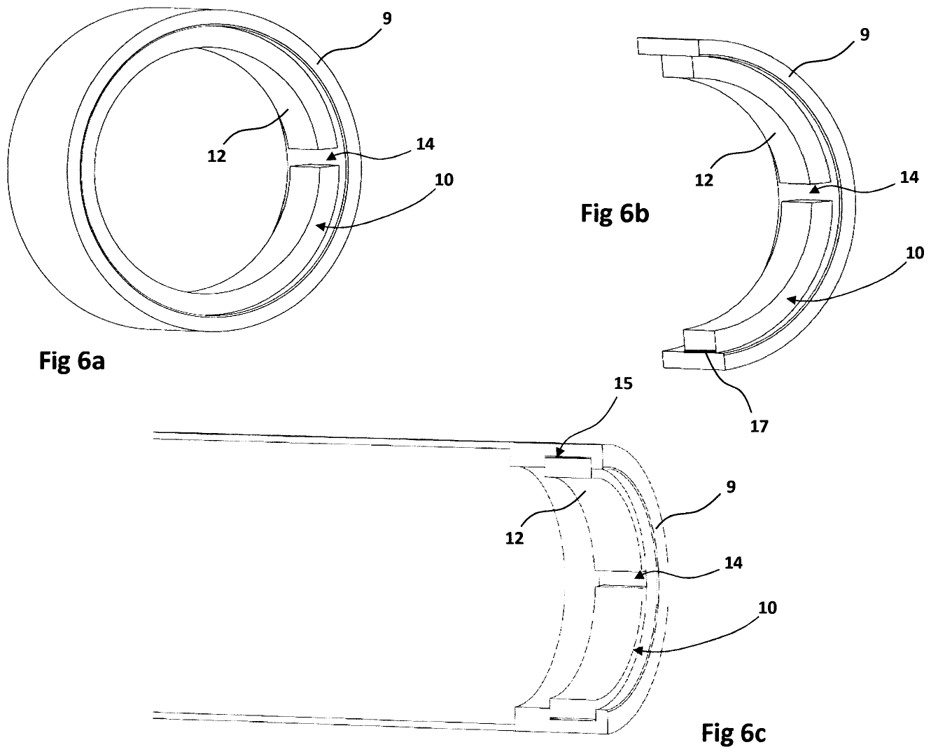

FIG. 6a shows in perspective view an exposed bearing device 10 according to the invention comprising a bearing cup 9 and a softer inner annular insulating bushing 12. The figure shows the ring of the bearing cup 9 in more detail and at its inside, the fixedly arranged and softer insulating bushing. The figure shows a gap 14 between the ends of the punched bushing material 12. This gap can in practice be for instance about 1 mm wide without compromising the function of the insulating bushing.

FIG. 6b shows in more detail the bearing device 10 according to the invention according to FIG. 6a, but here in section to show the constructive design of the bearing cup 9 and the insulating bushing 12 more clearly. The insulating bushing 12 thus consists of an inner ring of a substantially soft or cushioning material comprising a wear-resistant fibrous material. The insulating bushing 12 is fixedly arranged by means of an adhesive layer 17 at the bearing cup 9 and slides against the center shaft 6. The insulating bushing 12 may consist of one or more parts.

FIG. 6c shows in a section that the insulating bushing 12 does not necessarily have to be fixed to the bearing cup 9. The bearing cup 9 can for instance be made with a groove 15 which holds the insulating bushing 12 in place.

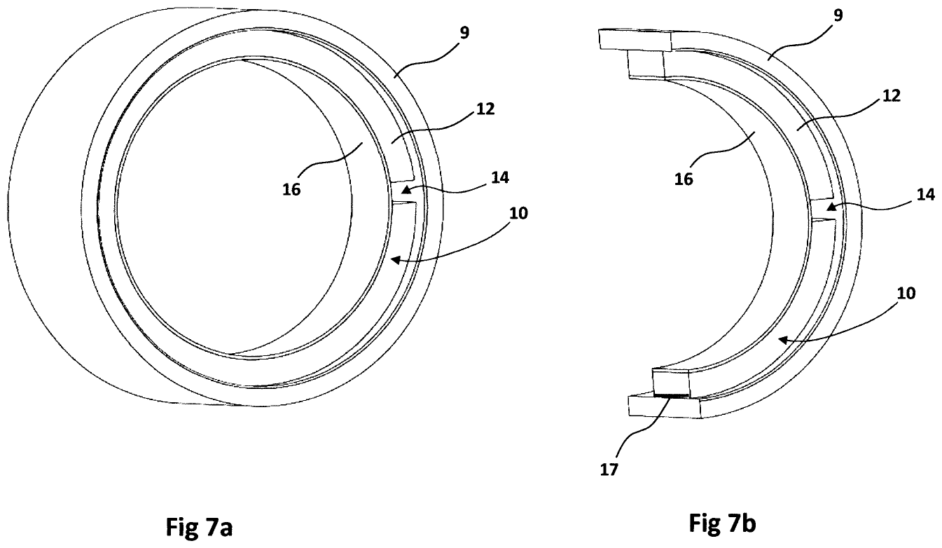

FIG. 7a shows in perspective view a bearing device 10 according to the invention corresponding to that shown in FIG. 6a and b but here also provided with an inner hard surface layer 16 in the form of a ring, fixed to the inner surface of the insulating bushing 12. This harder surface layer 16, may thus consist of a ring of a substance from the group of Polyamide, Polyester, Polyethylene, Teflon or the like and the purpose of this harder surface layer 16 is to reduce the friction further in the construction, at the same time as vibrations/noises from the bearing device 10 and the center shaft 6 still is damped by the insulating bushing 12.

FIG. 7b shows in perspective view and in a section corresponding bearing device 10 according to the invention shown in FIG. 7a. The adhesive layer 17 which fixes the insulating bushing 12 against the bearing cup 9 is also shown.

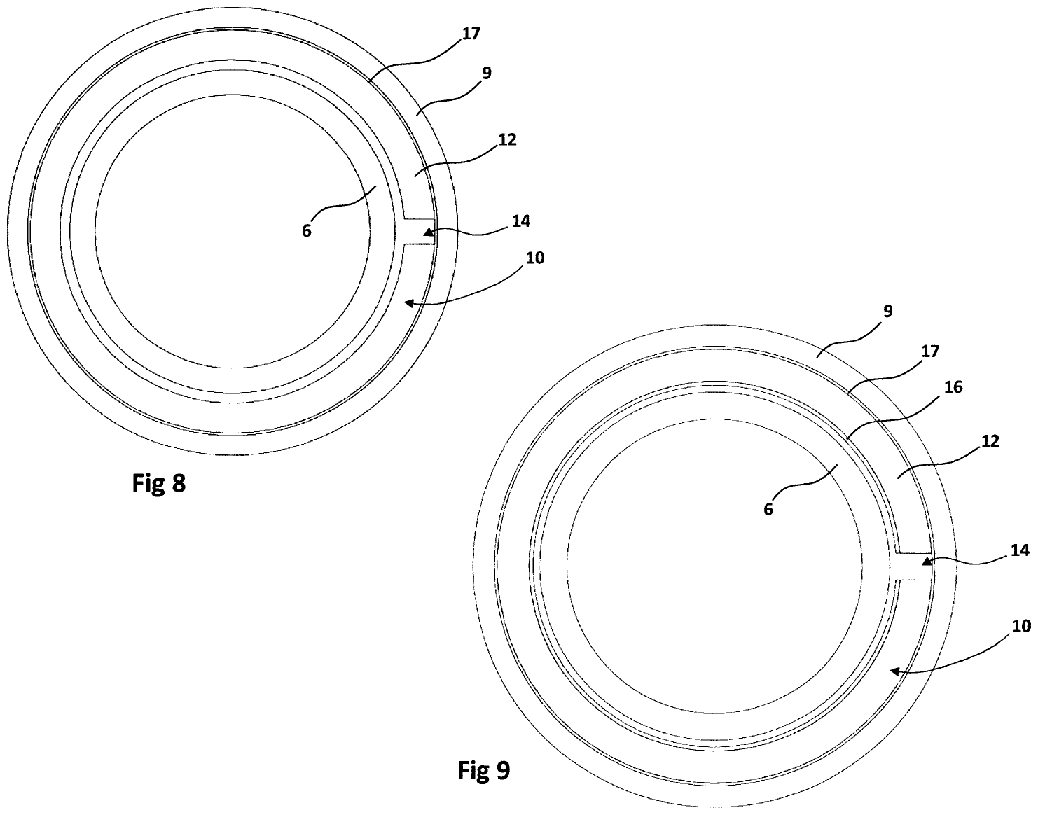

FIG. 8 shows in cross section a bearing device 10 according to the invention comprising an insulating bushing 12 mounted against the inside of the operating cylinder 5. The figure shows that there is a certain gap between the insulating bushing 12 and the center shaft 6, or the operating cylinder 5. This gap is typically about 0.8 mm but can be both larger and smaller. The gap is arranged to further reduce the risk for friction, vibration and/or noise. Also shown here is the adhesive layer 17 which fixes the insulating bushing 12 to the inside of the operating cylinder 5.

FIG. 9 shows that the inner harder layer/coat 16, can be provided by a coat/layer of e.g. a hard plastic. This hard plastic can be sprayed or brushed on the insulating bushing 12 in liquid form, or otherwise attached directly to the insulating bushing 12. Thin Teflon tape can also be used and fixed suitably via glue or self-adhesive to the insulating bushing 12.

Other embodiments are of course also possible within the scope of the presented inventive concept. The inner part of the bearing device 10 may consist of, or comprise, a substantially soft cushioning material of, for example, rubber. The surface of this material is advantageously in that case covered by a thin layer/layer of a harder material 16 with low friction such as e.g. Polyamide, Polyester, Teflon or the like which may be in the form of a fabric or a fabric/felt/mat or alternatively a hard ring as described above.

According to the invention, bearing devices 10 thus consist of the insulating bushing 12, with or without the harder layer/coat 16.

Of course, several layers of fibrous material can be used in the insulating bushing 12.

It is also conceivable to design a single long bearing device 10 (not shown) which is mounted between the center shaft 6 and the inside of the operating cylinder 5 as well as the insulating bushing 12, instead of being arranged in or against the inside of the operating cylinder 5, is mounted on the center shaft 6, preferably along the major part of the center shaft 6.

The above description is primarily intended to facilitate the understanding of the invention and the invention is of course not limited to the stated embodiments but also other variants of the invention are possible and conceivable within the scope of the inventive concept and the scope of the appended claims.

1-12. (canceled)

13. A bearing device (10) for a pointing device (1) and arranged between an operating cylinder (5) and a center shaft (6) thereof in order to dampen or eliminate friction, vibrations, or noises in or from the pointing device (1), the bearing device comprising:
an insulating bushing (12) comprising a resilient, soft, or damping material, the resilient, soft, or damping material comprising a fibrous material (13), which makes the insulating bushing (12) soft and dampening to vibrations or noises.

14. The bearing device (10) according to claim 13, wherein the resilient, soft, or damping material is made of, or has a layer of, a low friction material.

15. The bearing device (10) according to claim 13, wherein the bushing (12) is arranged in a cylindrical bearing cup (9) which in turn is attached to the operating cylinder (5).

16. The bearing device (10) according to claim 13, wherein the bushing (12) is arranged inside the operating cylinder (5).

17. The bearing device (10) according to claim 13, wherein the insulating bushing (12) consists of at least one part.

18. The bearing device (10) according to claim 13, wherein the insulating bushing (12) is provided with a layer of glue (17).

19. The bearing device (10) according to claim 13, wherein the insulating bushing (12) is provided with a hard material in the form of a layer or coat (16) on the side abutting the center shaft (6).

20. The bearing device (10) according to claim 19, wherein the hard material of the layer or coat (16) consists of a ring which is fixed to the insulating bushing (12) and which ring is arranged between the insulating bushing (12) and the center shaft (6).

21. The bearing device (10) according to one of claim 19, wherein the layer or coat (16) comprises at least one of the materials from the group consisting of Polyamide, Polyester, Polyethylene, and Polytetrafluoroethylene (PTFE).

22. The bearing device (10) according to one of claim 20, wherein the layer or coat (16) comprises at least one of the materials from the group consisting of Polyamide, Polyester, Polyethylene, and Polytetrafluoroethylene (PTFE).

23. The bearing device (10) according to claim 13, wherein radial play between the bushing (12) and the center shaft (6), or between the bushing (12) and the operating cylinder (5), is at least 0.8 mm, resulting in that the friction, vibrations, or noises between these parts is further reduced.
